(19) United States
(12) Patent Application Publication
(10) Pub. No.: US 2005/0108910 A1
(43) Pub. Date: May 26, 2005

(54) Apparatus and method for promoting new driver awareness

(76) Inventors: Erin Ann Esparza, Queen Creek, AZ (US); Jeffrey Scott Ingalls, Queen Creek, AZ (US)

Correspondence Address: Wright Law Group, PLLC, Suite 2, 7201 West Oakland, Chandler, AZ, 85226, US

(21) Appl. No.: 10/721,006

(22) Filed: Nov. 22, 2003

(51) Int. Cl. G09F 21/04

(52) U.S. Cl. 40/600; 40/591

(57) ABSTRACT

An integrated new driver awareness program is jointly implemented by identifying new drivers and enlisting the organizations that interact most frequently with new drivers to assist in a coordinated educational effort, both for the new drivers and other drivers on the road. By visually identifying new driver's vehicles with a series of indicia and making other drivers on the roads more aware of the new driver's presence, status, and and/or proficiency level, the number of debilitating automobile accidents can be reduced. In the most preferred embodiment of the present invention, one or more visual indicators are affixed to the exterior and/or interior of a new driver's vehicle to alert other drivers that a new driver is operating a vehicle on the road.

### BACKGROUND OF THE INVENTION

1. Technical Field

The present invention relates generally to automobile safety and more particularly to promoting awareness of relatively inexperienced drivers in an effort to reduce accidents and the related negative consequences of accidents.

2. Background Art

Most individuals are aware that experience leads to proficiency for many activities. Nowhere is this more readily recognized than relationship between inexperienced drivers and traffic accidents. As widely reported in the popular media, motor vehicle crashes are the leading cause of death for American teenagers. For example, in 1997, 5,477 young people (passengers and drivers age 15-20) died in motor vehicle crashes. Additionally young people age 15-20 make up 6.7 percent of the total driving population in this country but are involved in 14 percent of all fatal crashes. Another study shows that in 1997, almost one quarter (22%) of those who died in speed-related crashes were youth aged 15-20.

In a similar vein, the Insurance Institute for Highway Safety says the per-mile risk of being involved in a crash is greatest for 16- and 17-year-old drivers—with the crash rate per mile driven being nearly three times greater for 16-year-olds than it is for 18- and 19-year-olds. Basing its conclusion on 1996 data, the American Automobile Association says 16- and 17-year-old drivers are seven times more likely to be involved in crashes than the general public. Also, highway crashes are the number-one killer of teenagers. Finally, in the last decade, over 68,000 teens have died in car crashes and approximately sixty-five percent of teen passenger deaths occur when another teenager is driving.

Many factors contribute to the prevalence of accidents involving inexperienced drivers. Inexperienced drivers, especially teenage drivers are more likely than older drivers to be the cause of their accidents. Immaturity is a contributing factor to the high rate of auto crashes and deaths among teenagers. For instance, speeding, tailgating and not using safety belts are miscalculations and misjudgments that younger, less experienced drivers make far more frequently than older drivers.

Yet another contributing factor for the inexperienced driver is the ever-increasing pace of traffic in general and the overly aggressive nature of many drivers on the road today. While experienced drivers can effectively cope with the high-pressure driving environment prevalent on most roadways, the younger, more inexperienced driver has less time to react and may respond poorly when confronted with a dangerous situation and split-second decisions. Even with the same amount of reaction time, the inexperienced driver may be confused and less proficient, thereby increasing the probability of an accident. The requirement to quickly and proficiently respond to rapidly evolving traffic situations can lead the inexperienced driver to make mistakes and, in turn, lead to undesirable automobile accidents.

Many different solutions have been proposed to address the current situation associated with inexperienced drivers. For example, new driver education programs have been initiated. Graduated driver's license programs have been proposed and adopted by many states. While somewhat effective, a graduated drivers' license program only offers a little more time for a new driver to gain experience prior to receiving an unrestricted driver's license. The graduated driver's license program does not provide an opportunity for third party drivers to become aware of the new driver's presence and lack of experience on the road. In a similar vein, some states are mandating additional training courses for new drivers in an attempt to reduce the number of accidents and deaths associated with the new drivers.

In addition to the, new safety devices such as side curtain airbags and anti-lock brakes have been incorporated into automobiles, in a concerted attempt to reduce the damage caused by the inexperienced driver. Unfortunately, while many of these measures have provided for some small decrease in the problems with the inexperienced driver, inexperienced drivers continue to be involved in a disproportionately high number of accidents on the roadways of America.

As shown by the discussion presented herein, the current situation with inexperienced drivers and the accidents caused by these inexperienced drivers is a significant problem, with no readily available solution on the horizon. Accordingly, unless further improvements and enhancements are made in the way new drivers are integrated into the traffic flow, unnecessary and unwanted automobile accidents will continue to cause a plague of injuries and property damage.

### BRIEF SUMMARY OF THE INVENTION

An integrated new driver awareness program is jointly implemented by identifying new drivers and enlisting the organizations that interact most frequently with new drivers to assist in a coordinated educational effort, both for the new drivers and other drivers on the road. By visually identifying new driver's vehicles with one or more indicia indicating the new driver's presence, status, and and/or proficiency level, the number of debilitating automobile accidents can be reduced. In the most preferred embodiment of the present invention, one or more selectively removable devices are affixed to the exterior and/or interior of a new driver's vehicle to alert other drivers that a new driver is operating the vehicle.

### BRIEF DESCRIPTION OF DRAWINGS

The preferred embodiments of the present invention will hereinafter be described in conjunction with the appended drawings, wherein like designations denote like elements, and:

FIG. 1 is a side view of an automobile displaying a selectively removable indicia-bearing new driver notification device in accordance with a preferred exemplary embodiment of the present invention;

FIG. 2 is a detailed view of a selectively removable indicia-bearing new driver notification device in accordance with a preferred exemplary embodiment of the present invention; and

FIG. 3 is a flow chart of a method for implementing a new driver awareness program in accordance with a preferred exemplary embodiment of the present invention.

### DETAILED DESCRIPTION OF THE PREFERRED EMBODIMENTS

The New Driver Awareness Program of the present invention incorporates a series of related products, protocols and procedures designed to enhance the awareness of new drivers on the roadway. By visually identifying new drivers on the roadway, other drivers can provide the inexperienced driver with more maneuvering room and consideration, thereby allowing the new driver a greater opportunity to avoid and/or recover from any mistakes or errors in judgment.

The most preferred embodiments of the present invention include a coordinated effort by and between schools, insurance companies, inexperienced drivers, governments, and other organizations. The present invention is most preferably an integral part of a comprehensive program that can be implemented in a coordinated manner by various organizations or agencies. For example, in the most preferred embodiments, the present invention may be an adjunct program to a new driver-training program offered by an educational institution such as a high school. In another preferred embodiment, an insurance company may sponsor the implementation of the present invention in order to reduce new driver-related accidents and the associated insurance costs. In yet another preferred embodiment of the present invention, the graduated driver's license program requirements of a governmental licensing agency are incorporated as a part of the invention. Any and all of these various approaches may be utilized alone or in combination to achieve the desired results of the present invention.

The most preferred embodiments of the present invention include a selectively removable notification device that may be affixed to the exterior surface or interior of a vehicle, thereby alerting other drivers to the new driver's presence, proficiency level, and status. By affixing a selectively removable new driver notification device to a vehicle being driven by an inexperienced driver, other drivers on the road can provide an additional “buffer” or “cushion,” thereby providing the inexperienced driver with additional opportunity to recover from mistakes or errors in judgment due to their inexperience.

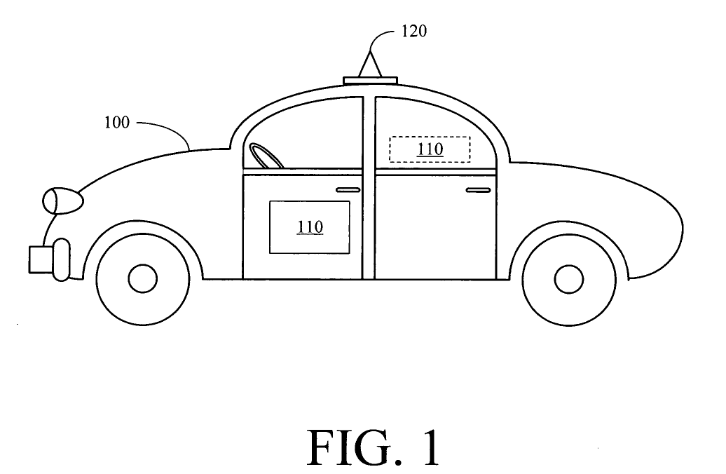

Referring now to FIG. 1, a preferred embodiment of the present invention is shown. As shown in FIG. 1, at least one selectively removable indicia-bearing new driver notification device 110 is affixed to a vehicle 100. As shown in FIG. 1, the exterior surface of a vehicle 100 is a suitable location for the at least one selectively removable indicia-bearing new driver notification device 110. It should be noted that the at least one selectively removable indicia-bearing new driver notification device 110 may also be positioned and affixed to a location in the interior, or passenger compartment, of vehicle 100, while remaining visible from the exterior of vehicle 100. The most desirable location is that location which can provide the appropriate level of visibility for at least one selectively removable indicia-bearing new driver notification device 110. Additionally, while vehicle 100 is depicted as a passenger car in FIG. 1, any type of vehicle that may be operated by a new driver is within the scope of the present invention.

Although depicted as being affixed to the driver side front door of vehicle 100 in FIG. 1, it should be noted that in the most preferred embodiments of the present invention, multiple selectively removable indicia-bearing new driver notification devices 110 are affixed onto or inside vehicle 100. For example, a typical application may include three selectively removable indicia-bearing new driver notification devices 110; with one affixed to the driver side front door of vehicle 100, another selectively removable indicia-bearing new driver notification device 110 being affixed to the passenger side front door of vehicle 100, and another selectively removable indicia-bearing new driver notification device 110 affixed to the rear of the vehicle 100. Additionally, it may be desirable to provide a selectively removable indicia-bearing new driver notification device 120 for placement on the roof of vehicle 100, either by itself or in conjunction with other selectively removable indicia-bearing new driver notification devices 110. Additionally, selectively removable indicia-bearing new driver notification device 120 may include an internal illumination source or mechanism to provide enhanced visibility during the hours of darkness.

In the most preferred embodiments, selectively removable indicia-bearing new driver notification device 110 is manufactured from a magnetic material so that it is easily affixed to a metallic surface, such as vehicle 100. Additionally, selectively removable indicia-bearing new driver notification device 110 is capable of being printed on by a variety of methods so as to provide various types display indicia. Recognizing that some vehicles 100 may have an exterior surface comprising a non-metallic material, alternate manufacturing materials and methods may be employed for manufacturing selectively removable indicia-bearing new driver notification device 110. Additionally, selectively removable indicia-bearing new driver notification device 110 may be affixed inside vehicle 100, by using suction cups or some other method of attachment. For the most preferred embodiments of the present invention, a highly visible location is selected for one or more selectively removable indicia-bearing new driver notification device 110. For further enhancing the visibility of selectively removable indicia-bearing new driver notification devices 110 and 120, a reflective material or “glow-in-the-dark” material may be used in the manufacturing process.

Additionally, although magnetic affixation is presently the most preferred method for attaching selectively removable indicia-bearing new driver notification device 110 to the exterior surface of vehicle 100, any method known to those skilled in the art for selectively attaching indicia-bearing devices to vehicle 100 are contemplated for use in conjunction with the methods of the present invention. This may include various types of straps, suction cups, adhesive-backed stickers, and/or decals manufactured from various “static cling” materials and the like. Factors such as visibility and the ability to remain fixed in a relatively visible position on the exterior surface or in the interior of vehicle 100 are the primary considerations for material selection and placement of selectively removable indicia-bearing new driver notification device 110.

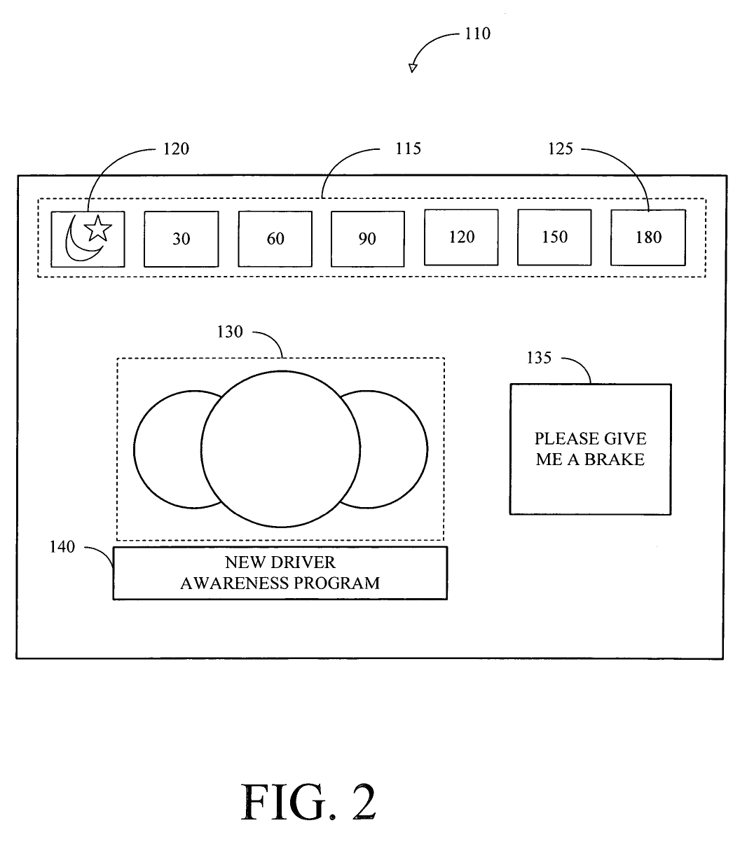

Selectively removable indicia-bearing new driver notification device 110 will most preferably display indicia suitable to indicate that vehicle 100 is being operated by a new driver, that is, a driver with relatively little driving experience. Additionally, selectively removable indicia-bearing new driver notification device 110 may also display additional indicia to indicate the level of proficiency of the new driver. While any indicia that are capable of identifying the presence of the new driver and/or displaying driver proficiency indicia are suitable for adaptation with the present invention, the most preferred embodiments for various types of indicia are described in conjunction with FIG. 2.

Given that selectively removable indicia-bearing new driver notification device 110 is selectively removable, selectively removable indicia-bearing new driver notification device 110 may be quickly and easily affixed to or removed from vehicle 100. This allows vehicle 100 to be configured for an inexperienced drive by affixing selectively removable indicia-bearing new driver notification device 110 to the exterior surface of vehicle 100. Then, whenever a relatively more experienced driver operates vehicle 100, selectively removable indicia-bearing new driver notification device 110 may be quickly and easily removed from the exterior surface of vehicle 100.

Referring now to FIG. 2, a selectively removable indicia-bearing new driver notification device 110 in accordance with a preferred embodiment of the present invention most preferably includes at least one indicia for indicating the new drivers' presence, status or proficiency level. The observance of a new driver presence indicator, a new driver status indicator, and/or a new driver proficiency level indicator can alert other drivers of the new driver's presence and convey additional information about the new driver. As shown in FIG. 2, these various indicia can take many forms.

For example, indicia 115 could be permanently or removably affixed to selectively removable indicia-bearing new driver notification device 110. By affixing indicia 115 to selectively removable indicia-bearing new driver notification device 110, indicia 115 can be used as new driver status indicators and/or new driver proficiency level indicators. In the case of new driver status indicators, indicia 120 may be a visual indicator depicting the moon and/or stars, signifying that the new driver has been cleared for nighttime driving. In a similar fashion, one or more new driver proficiency level indicators 125 may be used to indicate the number of days that a new driver has been driving. In this case, every thirty days an additional new driver proficiency level indicator 125 has been affixed to selectively removable indicia-bearing new driver notification device 110, thereby indicating the number of days that the new driver has been operating a motor vehicle.

Indicia 130, 135, and 140 are additional examples of various indicia that might be used as new driver presence indicators, that is, alerting other drivers to the fact that a relatively inexperienced driver is operating the vehicle. Indicia 130 is a logo that may be associated with the sponsoring organization that provided selectively removable indicia-bearing new driver notification device 110. Indicia 135 and 140 are sample slogans or catchphrases that may be employed to identify the presence of a new driver. Those skilled in the art will recognize that various combinations of colors, words, letters, logos, symbols, etc. may be readily adapted for use as new driver status indicators 120, new driver proficiency level indicators 125, and/or new driver presence indicators 130, 135, and 140. In the most preferred embodiments of the present invention, indicia 120, 125, 130, 135, and/or 140 are adhesive-backed stickers or labels configured to be adhered to the surface of selectively removable indicia-bearing new driver notification device 110. Those skilled in the art will recognize that indicia 120, 125, 130, 135, and/or 140 may be affixed to selectively removable indicia-bearing new driver notification device 110 via many other suitable methods.

In the various preferred embodiments of the present invention, selectively removable indicia-bearing new driver notification device 10 will display various combinations of new driver status indicators 120, new driver proficiency level indicators 125, and/or new driver presence indicators 130, 135, and 140. In the most preferred embodiments of the present invention, new driver presence indicators 130, 135, and 140 will be displayed on selectively removable indicia-bearing new driver notification device 110. Additionally, it should be noted that although the selectively removable indicia-bearing new driver notification device 110 of FIG. 2 depicts the various indicia as being displayed on a single selectively removable indicia-bearing new driver notification device 110, the various indicia may be displayed on multiple selectively removable indicia-bearing new driver notification devices 110 without departing from the spirit and scope of the present invention.

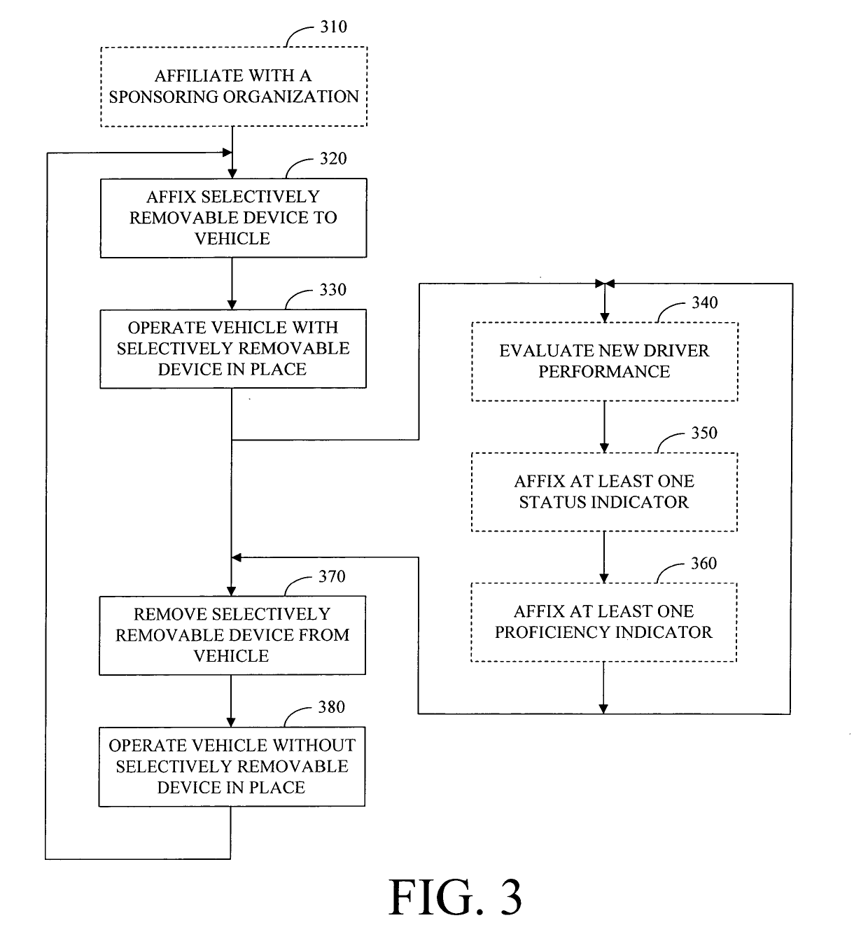

Referring now to FIG. 3, a method 300 for implementing a New Driver Awareness Program in accordance with a preferred exemplary embodiment of the present invention is depicted. As shown in FIG. 3, at least one preferred embodiment of the present invention contemplates affiliating with a sponsoring organization as part of method 300 (step 310). Step 310 is included because it is recognized that certain organizations have a tremendous amount of influence over their constituents and can be instrumental in providing a catalyst for implementation of new programs. While not a required step, step 310 is viewed as highly desirable in order to maximize the adoption and the rapid proliferation of the new driver awareness program. Additionally, a sponsoring organization may provide funding to manufacture and distribute the selectively removable indicia-bearing new driver notification devices of the present invention.

Additionally, in order to raise the stature of the new driver awareness program, certain organizations may include a contractual element to the program. For example, an insurance company may provide funding for the selectively removable indicia-bearing new driver notification device and provide a discount in the insurance rates for those new drivers that sign a contract promising to display the selectively removable indicia-bearing new driver notification device on their vehicle at the appropriate times. Similarly, a governmental licensing agency that issues driver's licenses may adopt a new driver awareness program using the selectively removable indicia-bearing new driver notification device of the present invention and require the display of the selectively removable indicia-bearing new driver notification device as part of the process for obtaining a driver's license. Other similar applications will be apparent to those skilled in the art.

Once the new driver awareness program has been adopted and the selectively removable indicia-bearing new driver notification devices prepared for use, one or more selectively removable indicia-bearing new driver notification devices may be affixed to a vehicle (step 320). As previously discussed, the vehicle may then be operated by the inexperienced driver (step 330) and other drivers may be alerted to the presence, status and level of proficiency for the inexperienced driver, based on the selectively removable indicia-bearing new driver notification device.

Whenever the vehicle is to be operated by an experienced driver, the selectively removable indicia-bearing new driver notification device may be removed from the vehicle (step 370) and the vehicle may be operated without the selectively removable indicia-bearing new driver notification device in place (step 380). This allows a given vehicle to be operated at any given time by multiple operators, both experienced and inexperienced. As depicted by FIG. 3, the process of alternately affixing and removing the selectively removable indicia-bearing new driver notification device may be repeated as necessary.

In certain preferred embodiments of the present invention, the new driver awareness program will include additional optional steps (steps 340, 350, and 360). The optional program steps provide for a periodic evaluation of the new driver or inexperienced driver's performance (step 340) followed by the affixation of at least one new driver status indicator (step 350) or new driver proficiency indicator (step 360). This process may be repeated as desired and or necessary until the new or inexperienced driver reaches the desired level of proficiency. The addition of additional indicators can be used to reflect the enhanced status or skill level of the new driver, as warranted. This repetition would conclude and eventually lead to a “graduation” from the new driver awareness program, after the desired levels of proficiency have been attained.

From the foregoing description, it should be appreciated that apparatus and methods for a new driver awareness program are provided and present significant benefits that would be apparent to one skilled in the art. Furthermore, while multiple embodiments have been presented in the foregoing description, it should be appreciated that a vast number of variations in the universe of preferred embodiments exist. For example, the possible combinations of style, size, color and content of the indicia displayed in or on a vehicle are virtually unlimited. Similarly, the exact location for the placement of selectively removable indicia-bearing new driver notification device on a vehicle is likewise almost limitless. Additionally, those skilled in the art will recognize that many other devices may be suitably deployed to practice the functions of the selectively removable indicia-bearing new driver notification devices described herein.

While the new driver awareness program of the present invention may not prevent inexperienced drivers from driving too fast, or from making errors in judgment, by identifying the vehicle as being operated by a relatively inexperienced driver, other drivers will have their awareness of the situation heightened. It is anticipated that this will be of benefit for other drivers on the road inasmuch as other drivers may give the relatively inexperienced driver more of a “cushion” on the roadway, thereby providing additional opportunity for the inexperienced driver to recover from their mistakes. For example, an experienced driver may be alerted to the presence of a new driver on the road by observing a selectively removable indicia-bearing new driver notification device 110 affixed to the exterior of a vehicle 100. Upon observing the selectively removable indicia-bearing new driver notification device 110, the more experienced driver may be motivated to follow a little less closely and/or otherwise be more cautious and/or courteous around vehicle 100.

Lastly, it should be appreciated that the illustrated embodiments are preferred exemplary embodiments only, and are not intended to limit the scope, applicability, or configuration of the invention in any way. Rather, the foregoing detailed description provides those skilled in the art with a convenient road map for implementing a preferred exemplary embodiment of the invention. Accordingly, it should be understood that various changes may be made in the function and arrangement of elements described in the exemplary preferred embodiments without departing from the spirit and scope of the invention as set forth in the appended claims.

1. An apparatus comprising:
at least one selectively removable indicia-bearing new driver notification device, said at least one selectively removable indicia-bearing new driver notification device being configured to be removably affixed to a motor vehicle, said at least one selectively removably indicia-bearing new driver notification device bearing at least one indicia indicating at least one of the presence, status or proficiency level of a new driver.

2. The apparatus of claim 1 wherein said at least one indicia indicating at least one of the presence, status or proficiency level of a new driver comprises a new driver presence indicator.

3. The apparatus of claim 1 wherein said at least one at least one indicia indicating at least one of the presence, status or proficiency level of a new driver comprises a new driver proficiency level indicator.

4. The apparatus of claim 1 wherein said at least one indicia indicating at least one of the presence, status or proficiency level of a new driver comprises a new driver status indicator.

5. The apparatus of claim 1 wherein said at least one indicia indicating at least one of the presence, status or proficiency level of a new driver comprises:
a new driver presence indicator;
a new driver status indicator; and
a new driver proficiency indicator.

6. The apparatus of claim 1 wherein said vehicle comprises:
an exterior surface;
a roof portion; and
an interior passenger compartment.

7. The apparatus of claim 6 wherein said exterior surface comprises at least a driver side door, a passenger side door and a rear portion and wherein said at least one selectively removable indicia-bearing new driver notification device comprises three magnetic decals and wherein one of said three magnetic decals is removably affixed to each of said driver side door, said passenger side door and said rear portion.

8. The apparatus of claim 6 wherein said at least one selectively removable indicia-bearing new driver notification device is located inside said interior passenger compartment.

9. The apparatus of claim 6 where said exterior portion comprises a roof portion and wherein said at least one selectively removable indicia-bearing new driver notification device is removably affixed to said roof portion.

10. The apparatus of claim 9 wherein said at least one selectively removable indicia-bearing new driver notification device contains an internal illumination source.

11. The apparatus of claim 1 wherein said at least one selectively removable indicia-bearing new driver notification device is manufactured from a reflective material.

12. An apparatus comprising:
a vehicle, said vehicle comprising an exterior surface;
a new driver operating said motor vehicle;
three selectively removable indicia-bearing new driver notification devices, each of said three selectively removable indicia-bearing new driver notification devices being removably affixed to said exterior surface of said motor vehicle, wherein each of said three selectively removable indicia-bearing new driver notification devices comprises at least one of a new driver presence indicator, a new driver status indicator, a new driver proficiency indicator.

13. The apparatus of claim 12 wherein each of said three selectively removable indicia-bearing new driver notification devices comprises:
a new driver presence indicator;
a new driver status indicator; and
a new driver proficiency indicator.

14. A method comprising step of affixing at least one selectively removable indicia-bearing new driver notification device to a vehicle, said at least one selectively removable indicia-bearing new driver notification device bearing at least one indicia indicating at least one of the presence, status or proficiency level of a new driver.

15. The method of claim 14 wherein said at least one selectively removable indicia-bearing new driver notification device to a vehicle comprises:
a new driver presence indicator;
a new driver status indicator; and
and a new driver proficiency indicator.

16. The method of claim 14 wherein said step of affixing at least one selectively removable indicia-bearing new driver notification device to a vehicle comprises the step of affixing said at least one selectively removable indicia-bearing new driver notification device to an exterior surface of said vehicle.

17. The method of claim 14 wherein said step of affixing at least one selectively removable indicia-bearing new driver notification device to a vehicle comprises the step of affixing said at least one selectively removable indicia-bearing new driver notification device inside a passenger compartment of said vehicle.

18. The method of claim 14 wherein said step of affixing at least one selectively removable indicia-bearing new driver notification device to a vehicle comprises the step of affixing said at least one selectively removable indicia-bearing new driver notification device to a roof portion of said vehicle.

19. A method comprising the steps of:
affiliating with a sponsoring organization;
affixing at least one selectively removable indicia-bearing new driver notification device to a vehicle when a new driver is preparing to operate said vehicle;
operating said vehicle with said at least one selectively removable indicia-bearing new driver notification device affixed to a vehicle to indicate at least one of the presence, status or proficiency level of a new driver operating said vehicle;
removing said at least one selectively removable indicia-bearing new driver notification device from said vehicle when said new driver is finished operating said vehicle.

20. The method of claim 19 further comprising the step of periodically evaluating the driving status of said new driver and affixing at least one of a new driver status indicator and a new driver proficiency indicator to indicate a change in the status or skill level of said new driver.
